(19) United States
(12) Patent Application Publication
(10) Pub. No.: US 2012/0291078 A1
(43) Pub. Date: Nov. 15, 2012

(54) SYSTEM AND METHOD FOR MODIFIED RERUNS

(75) Inventor: Srilal Weerasinghe, Austin, TX (US)

(73) Assignee: AT&T Intellectual Property I, LP, Atlanta, GA (US)

(21) Appl. No.: 13/106,100

(22) Filed: May 12, 2011

(51) Int. Cl. H04N 5/93; H04N 7/173

(52) U.S. Cl. 725/109; 386/278; 386/286; 725/115; 386/E05.028

(57) ABSTRACT

A system that incorporates teachings of the present disclosure may include, for example, a network device having a controller programmed to receive a rerun of a video program in an editable digital format streamed in an Internet Protocol Television system where the rerun has an identifier, initiate a search of a rerun database for video clips matching the identifier, retrieve a rerun descriptor file associated with the identifier, determine an insertion point on the rerun for inserting a video clip matching the identifier using the rerun descriptor file, and substitute at the insertion point, a portion of the rerun with the video clip matching the identifier. Other embodiments are disclosed.

### FIELD OF THE DISCLOSURE

The present disclosure relates generally to communication systems and more specifically to a system and method for metamorphic content generation.

### BACKGROUND

Interactive TV networks and other video networks provide a multitude of services including broadcast programming and video-on-demand. These networks reach out to users in various environments including single family residences, multi-dwelling apartments and commercial facilities. The content within a given channel or among a number of channels may lose the interest of viewers when the content is played multiple times. As the number of channels increase on a particular system and as the number of access venues proliferate, it may also be more difficult to retain the interest of a viewer to a particular channel or to a particular source of access to such content.

### BRIEF DESCRIPTION OF THE DRAWINGS

FIGS. 1 and 4 depict illustrative embodiments of communication systems that morph content;

FIG. 2 depicts an illustrative embodiment of a portal interacting with the communication system of FIG. 1;

FIG. 3 depicts an illustrative embodiment of a communication device utilized in the communication system of FIG. 1;

FIG. 5 depicts an illustrative embodiment of a method operating in portions of the communications systems of FIGS. 1 and 4;

FIG. 6 depicts another illustrative embodiment of a method operating in portions of the communications systems of FIGS. 1 and 4

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail a network device comprising a controller programmed to receive a rerun of a video program in an editable digital format streamed in an Internet Protocol Television system where the rerun has an identifier, initiate a search of a rerun database for video clips matching the identifier, retrieve a rerun descriptor file associated with the identifier, determine an insertion point on the rerun for inserting a video clip matching the identifier using the rerun descriptor file, and substitute at the insertion point, a portion of the rerun with the video clip matching the identifier.

Another embodiment of the present disclosure can entail a non-transitory computer readable storage medium comprising computer instructions to receive a rerun of a video program in an editable digital format, wherein the rerun has an identifier, initiate a search of a rerun database for program clips matching the identifier, retrieve a descriptor file associated with the identifier, and substitute at an insertion point defined by the descriptor file, a portion of the rerun with the program clip matching the identifier.

Yet another embodiment of the present disclosure can entail a method including transmitting a rerun of a video program in an editable digital format to at least one client device in a network where the video program was previously presented at the at least one client device and the rerun has an identifier, initiating a search of a rerun database for video clips matching the identifier, retrieving a rerun descriptor file associated with the identifier, and determining an insertion point on the rerun for inserting a video clip matching the identifier using the rerun descriptor file. The method can also replace a portion of the rerun at the insertion point with the video clip matching the identifier to create a modified rerun.

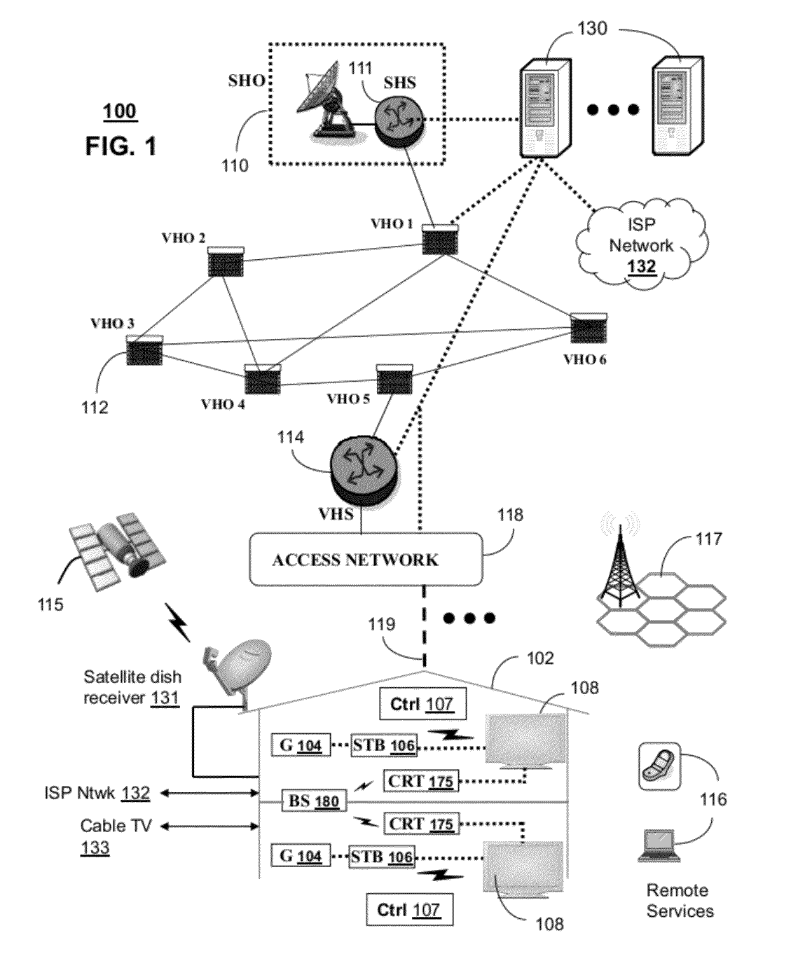

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The building 102 can be various types including multi-dwelling units which house a plurality of different subscribers. The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

Another distinct portion of the computing devices 130 can function as a server (herein referred to as server 130). The server 130 can use common computing and communication technology to perform the function of relaying and/or receiving media content to ISP network 132 or to other networks. The server 130 can perform all or some of the claimed functions herein in various embodiments contemplated herein.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services. Embodiments herein are also applicable to special purpose TV networks such as health TV networks in physician offices or hospital waiting rooms for example.

In one embodiment, the building 102 can have a surveillance system (not shown) including various security devices such as security cameras, motion detectors, automated door locks, intercoms, processors and so forth. Each of the units and/or subscribers within the building 102 can have a cognitive radio transceiver (CRT) 175 that can wirelessly receive signals from the surveillance system through a base station 180 as shown. The signals can be video media captured by security cameras throughout the building (such as at the front door, the pool, and so forth).

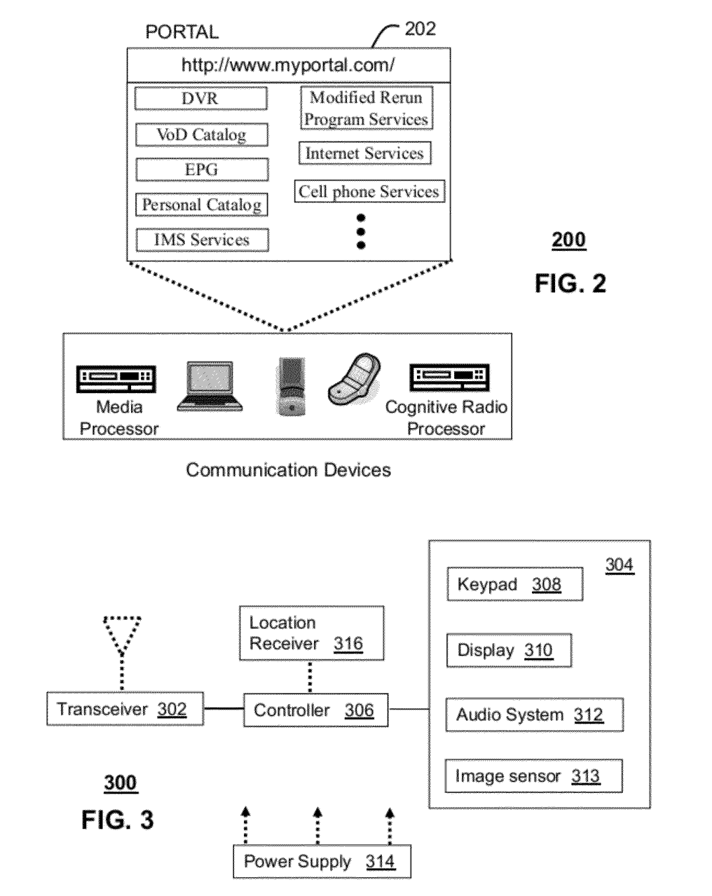

FIG. 2 depicts an illustrative embodiment of a portal 202 which can operate from the computing devices 130 described earlier of communication system 100 illustrated in FIG. 1. The portal 202 can be used for managing services of communication system 100. The portal 202 can be accessed by a Uniform Resource Locator (URL) with a common Internet browser such as Microsoft's Internet Explorer™ using an Internet-capable communication device such as those described for FIG. 1. The portal 202 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services, provisioning Internet services, provisioning cellular phone services, provisioning surveillance services, morphing services and so on. For example, a user can utilize the portal to configure a media processor, computer, cellular phone or other device to receive modified video programs or modified reruns that can be forwarded to yet other communication devices and/or entities, such as a mobile telephone or set top box of the user. The modified rerun programming services can enable access to alternate video clips for reruns that are generated during production of programs, but also after production or post-production by the producers of the original program or by independent third parties.

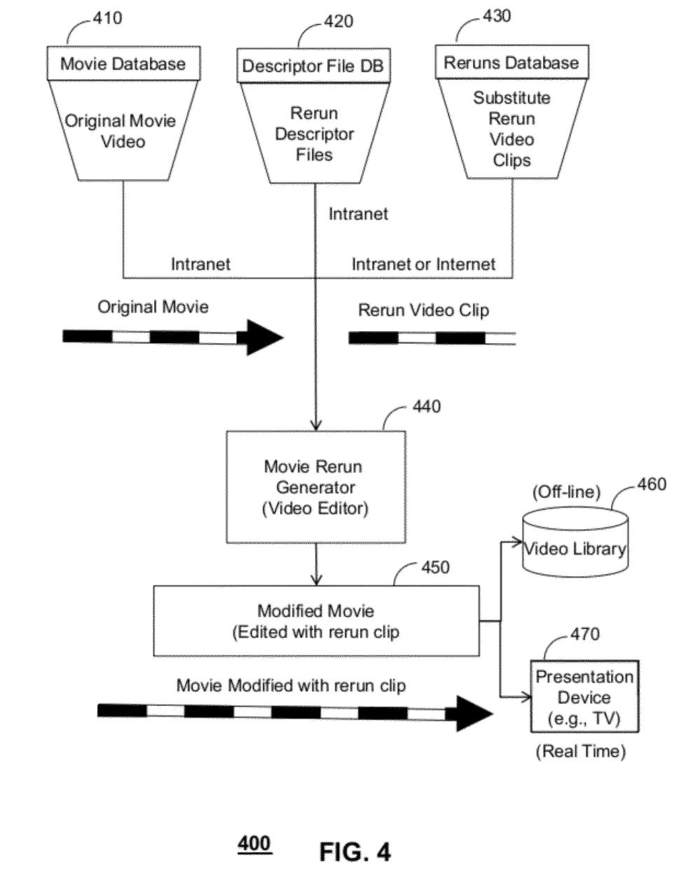

FIG. 3 depicts an exemplary embodiment of a communication device 300. Communication device 300 can serve in whole or in part as an illustrative embodiment of the communication devices of FIG. 1. The communication device 300 can comprise a wireline and/or wireless transceiver 302 (herein transceiver 302), a user interface (UI) 304, a power supply 314, a location receiver 316, and a controller 306 for managing operations thereof. The transceiver 302 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 302 can also be adapted to support circuit-switched wireline access technologies (such as PSTN), packet-switched wireline access technologies (such as TCPIP, VoIP, etc.), and combinations thereof.

The UI 304 can include a depressible or touch-sensitive keypad 308 with a navigation mechanism such as a roller ball, joystick, mouse, or navigation disk for manipulating operations of the communication device 300. The keypad 308 can be an integral part of a housing assembly of the communication device 300 or an independent device operably coupled thereto by a tethered wireline interface (such as a USB cable) or a wireless interface supporting for example Bluetooth. The keypad 308 can represent a numeric dialing keypad commonly used by phones, and/or a Qwerty keypad with alphanumeric keys. The UI 304 can further include a display 310 such as monochrome or color LCD (Liquid Crystal Display), OLED (Organic Light Emitting Diode) or other suitable display technology for conveying images to an end user of the communication device 300. In an embodiment where the display 310 is touch-sensitive, a portion or all of the keypad 308 can be presented by way of the display.

The UI 304 can also include an audio system 312 that utilizes common audio technology for conveying low volume audio (such as audio heard only in the proximity of a human ear) and high volume audio (such as speakerphone for hands free operation). The audio system 312 can further include a microphone for receiving audible signals of an end user. The audio system 312 can also be used for voice recognition applications. The UI 304 can further include an image sensor 313 such as a charged coupled device (CCD) camera for capturing still or moving images.

The power supply 314 can utilize common power management technologies such as replaceable and rechargeable batteries, supply regulation technologies, and charging system technologies for supplying energy to the components of the communication device 300 to facilitate long-range or short-range portable applications. The location receiver 316 can utilize common location technology such as a global positioning system (GPS) receiver for identifying a location of the communication device 300 based on signals generated by a constellation of GPS satellites, thereby facilitating common location services such as navigation.

The communication device 300 can use the transceiver 302 to also determine a proximity to a cellular, WiFi or Bluetooth access point by common power sensing techniques such as utilizing a received signal strength indicator (RSSI) and/or a signal time of arrival (TOA) or time of flight (TOF). The controller 306 can utilize computing technologies such as a microprocessor, a digital signal processor (DSP), and/or a video processor with associated storage memory such a Flash, ROM, RAM, SRAM, DRAM or other storage technologies.

The communication device 300 can be adapted to perform the functions of the media processor 106, the media devices 108, or the portable communication devices 116 of FIG. 1. It will be appreciated that the communication device 300 can also represent other common devices that can operate in communication system 100 of FIG. 1 such as a gaming console and a media player.

Embodiments herein are suitable for video content that may be seen multiple times in the form of reruns. Reruns of popular movies and sitcoms are a common way of generating TV ad revenue. Although reruns cost less than new movies, the viewership would diminish with each airing as the novelty is worn off. Once the viewers become too familiar with a movie plot they tend to watch the scenes of interest only. As repetition brings boredom, frequent channel surfing by viewers is common. This can lead to low viewership and diminished ad revenue for a network operator. This pattern generally becomes more acute when the same movie is aired several times a day or for several consecutive days, (as in cable TV). Even a popular video will continue to lose viewers as the storyline loses its novelty. Note that this issue is not limited to movies. The general trend toward diminished viewership can also apply to popular TV shows, sitcoms, episodes, and comedy shows which can result in potential revenue loss during such reruns.

One way to pique or at least maintain viewer interest is to present a modified version of the video program or movie to the audience each time the video program is aired. If the movie is not as predictable as the viewers first thought, then such unpredictability can arouse viewer curiosity. For example, the dialogue in the rerun video segment could be made slightly different from that of the original movie. Or the rerun may contain an alternate camera angle, different dresses, additional actors, computer generated modifications, avatars, backgrounds, landscapes, colorization, or any other number of variations. Note that the substitute programming can be a video clip, an audio clip, or other programming that can be inserted, spliced or overlaid onto or into the original video programming.

Interestingly, these embodiments will please many movie or TV editors and screenplay writers since a movie maker is often presented with two equally comparable choices of audio or video segments for use in a program. Yet one clip is typically discarded in favor of another because in the finished product there is room for only one version. As facilitated by the present disclosure, the second (discarded) choice can now make its way into a rerun within a broadcast network system such as an Interactive Television or Internet Protocol Television network.

In the movie industry today, movies and sitcoms are generally made once and replayed countless times. The technological challenges thus far have precluded any modifications to this model until now. However, digital TV presents a novel opportunity. Without creating an entirely different movie, one or many short video clips of alternate footage can be inserted seamlessly and dynamically to the main movie. Viewer interest can be maintained because each time the movie is played back, the presentation will be slightly different than the previous screening due to the use of alternate or substitute video or program clips. In general, multiple alternate scenes or additional footage needed for reruns could be done during pre-production and filmed along with the main movie. Alternately, computer generated substitute video clips for reruns could be created later (post-production), even by 3rd parties, as facilitated by the embodiments herein.

One master version of the movie (i.e., the one shown in the theatres and included in an official DVD) will generally be the main or original program or work. Methodologies herein can introduce minor modifications to an original movie or TV-episode so that reruns can avoid diminished viewership. Understandably this can be done without deviating much from the original theme of the movie if an author or producer or copyright owner limits such deviations, but the embodiments herein are not necessarily limited to an original theme and can deviate drastically assuming appropriate permissions are granted by copyright owners.

Viewers would be thrilled that movie reruns still contain some novelty and thus more enjoyable. Advertisers would find the higher viewership benefitting their marketing dollar. The network operators can potentially earn more from enhanced ad sales. Movie studios may undergo a paradigm shift due to planning and increased focus on alternate video segments (targeted for reruns). A potential application of the embodiments can include futuristic computer generated movie modifications such as those based on avatars. In this case, the alternate video clips for reruns can be generated post production, even by independent 3rd parties. A requirement can entail public access to unlocked/editable multimedia. Further note that embodiments herein are applicable to any form of digital video available on 3-screens (TV, mobile and internet).

Utilizing the recent advances in digital video editing, it is possible to introduce subtle modifications to TV and movie reruns to maintain their novelty. The embodiments herein can entail the process of creating reruns from major movie studios to independent 3rd parties. For example, such processes can involve off-line or non-real-time editing and presentation and alternatively can involve real-time editing and presentation.

With off-line or Non Real-Time mode, the TV or movie video is modified in a central location prior to each rerun and fed to the distribution network. All geographical regions can generally see the same modified movie. In a real-time mode, the Rerun video clip is spliced or otherwise inserted or over-laid in real time onto the original TV/movie video, which is being aired at the time. The implementation is more sophisticated than ‘non real-time’, but the movie modification can be executed per each geographic region independently. Other embodiments can be executed on a per premise or per client device basis independently.

Referring to FIG. 4, a system 400 of creating modified programming such as modified video reruns. The components of the system 400 assumes the original work or programming such as a movie, TV sitcom, show, or episode is not in a ‘locked’ form but can be accessed and edited such as by a video editor. The rerun program clips or video clips are assumed to be created during movie or TV show production and are placed in a data repository such as a movie database 410 that is accessible via intranet or secure internet. The ability to access the videos over a network would mean that the editing/splicing function can be performed in a geographically dispersed location. A software module named herein as a Movie Rerun Generator (MRG) 440 can serve as automated video editor/splicer with specific capabilities as further described below.

The system 400 can include the TV/Movie main video stored in the movie database 410: The original movie, TV show/episode, or game can be in a digitally editable decoded, non proprietary format, such as MPEG or AVI. A rerun database 430 can comprise rerun substitution video clips which can be any number of short video clips (files) or other programming clips or files (such as audio clips) that will be used in replacing the segments of the original TV/Movie video. A descriptor file database 420 can comprise a rerun descriptor data file or catalog which can be a machine-readable data file containing information about the main movie and reruns and the alternative program or video clips. The rerun descriptor files can comprise among other items, a unique identifier or ID of the main movie, a unique IDs of each of the reruns applicable to main movie, a timestamp for locating each ‘insertion point’ for reruns on the main movie, and a description of applicable reruns (length of reruns, format etc.). A sample rerun descriptor file format is illustrated below:

Sample Rerun Descriptor File Format

Main Movie/TV show Name -
Unique ID -
Length, Format and other Data -
Rerun Video Clip-1
Unique ID -
Insertion Point Location Identifier -
Length, Format and other Data -
Short Description -
Last Rerun Date & Time -
Rerun Video Clip-2
Unique ID -
Insertion Point Location Identifier -
Length, Format and other Data -
Short Description -
Last Rerun Date & Time -

The movie rerun generator 440 can be a software module that could either be part of the existing video editor/program insertion unit. It may also reside in a separate server. The movie rerun generator 440 can primarily be a video editor with additional capabilities to carry out various functions in an automated fashion. To enable automation, the movie rerun generator module will have programmatic interfaces to retrieve and interpret Rerun descriptor files from other databases.

To splice the rerun video clip on to the main video, the location and preferably the exact location of the rerun insertion point (splice point) should be identified. Each frame of a digital video commonly has an identifying sequence tag or time stamp. For the purposes of the embodiments herein, it is sufficient to assume the splice point is known or supplied by the original movie/TV-sitcom creator (e.g. movie studio). Alternately the splice point can be determined by the movie rerun generator module by scanning the main movie video. The movie rerun generator can intelligently search for the first occurrence of the first-frame of the Rerun video clip. Therefore the movie rerun module 440 can have image identification capabilities that are not typically used in digital television or internet protocol television systems.

In general, alternate (substitute) video clips for reruns can be produced during the original movie production. The same actors and same production settings could be used. However reruns could also be created post-production. Post production would be the case if the rerun modifications are limited to a studio/lab environment or if the substitute clips are generated by means of a computer program (instead of using real actors or settings as in the original movie). Some examples would be audio only changes, computer generated modifications to facial expressions, or adding avatar characters to an existing video.

Some of the pre-work can involve having the rerun clips created during movie/TV production and supplied with the original video. The rerun clips may also be created post-production by movie studios or 3rd parties. The reruns can be placed in an accessible database in machine readable form such as in the database 430 in FIG. 4.

Activities during the Rerun creation entail the original movie being scheduled for presentation or broadcast. Further, the movie rerun generator 440 can programmatically accesses the Rerun database 430 (via intranet or internet). The movie rerun generator 440 can seek matching rerun video clips for the original movie ID. If any are found, the rerun video clips are retrieved from database 430 and descriptor files are retrieved from database 420. If there is more than one rerun clip for a given movie/TV-sitcom, it will use pre-defined logic to determine which video clip to be selected for rerun. An example would be the case if there are two video clips for the same movie. If video clip-1 has already been used during the last rerun, then the logic would select video clip-2 for the present rerun. The movie rerun generator determines the location of the ‘insertion point’ on the main video (via time stamp or similar mechanism), can position the rerun video clip, and carry out the video substitution (splicing/editing or insertion) of the rerun video clip on to the main/original video to form the modified program or modified movie 450. If in an off-line mode, the modified main program 450 is stored in a video library 460 for use in a next rerun. If in a real-time mode, then the original video is already being broadcasted and the rerun video clip is substituted for the segment that needs to be modified and the modified program or modified movie is presented at a presentation device 470.

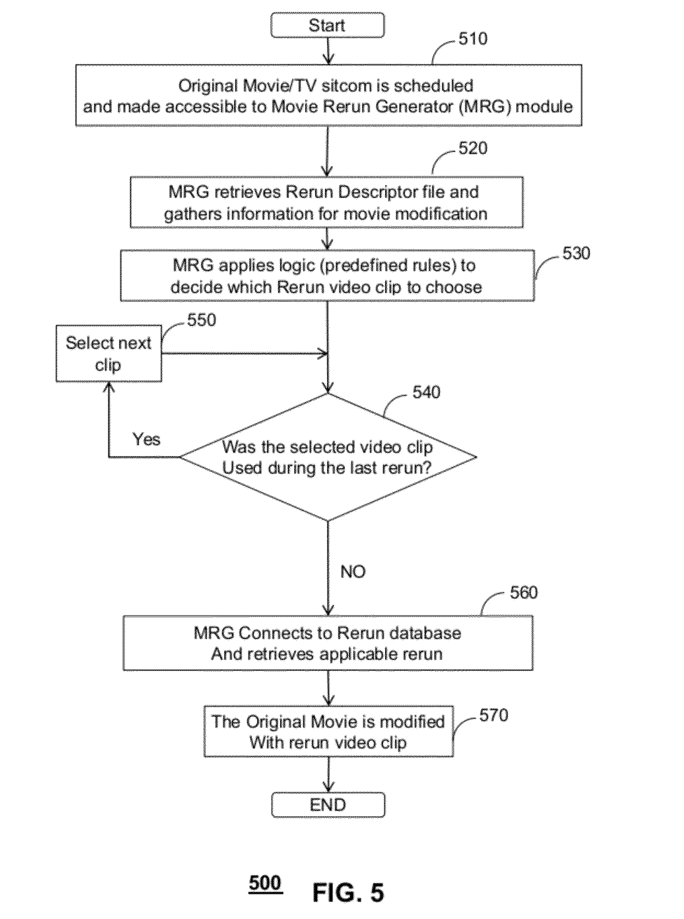

Referring to FIG. 5, a method 500 for modified reruns is illustrated. At 510, the method starts by scheduling an original program such as an original movie or TV sitcom and making such original program accessible to a movie rerun generator module. The movie rerun generator can retrieve a Rerun Descriptor file or files and gather information for movie modification at 520. At 530, the movie rerun generator can apply logic or predefined rules to decide which rerun video or program clips to choose for substitution in the original program. As decision block 540, a determination is made whether the selected video clip was used during the last rerun. If so, then a next program clip is selected for substation at 550. If the selected video clip was not used during the last rerun at 540, then the movie rerun connects to Rerun database and retrieves applicable rerun at 560. At 570, the original movie is modified with the rerun video clip.

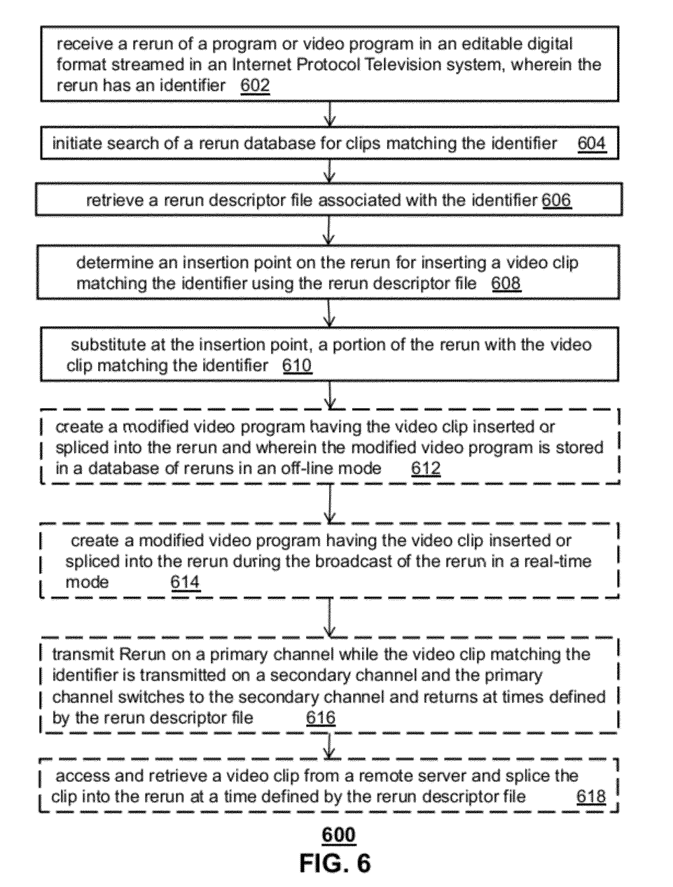

Referring to FIG. 6, another method 600 for modifying reruns is illustrated. The method 600 can begin by receiving a rerun of a program or video program in an editable digital format at 602 which can be streamed in an Internet Protocol Television system. The rerun can have an identifier as noted above. At 604, the method 600 can initiate a search of a rerun database for video clips matching the identifier. At 606, the method can retrieve a rerun descriptor file associated with the identifier. At 608, the method can determine an insertion point on the rerun for inserting a video clip matching the identifier using the rerun descriptor file. At 610, the method can substitute at the insertion point, a portion of the rerun with the video clip matching the identifier. The rerun descriptor file can comprise a unique identifier for the rerun, a length of the rerun, a format of the rerun, and an insertion point location identifier for at least one rerun video clip. The rerun descriptor file can further comprise a last rerun date and time.

In one alternative, the method at 612 can create a modified video program having the video clip inserted or spliced into the rerun and wherein the modified video program is stored in a database of reruns in an off-line mode. In yet another alternative at 614, the method can create a modified video program having the video clip inserted or spliced into the rerun during the broadcast of the rerun in a real-time mode. Note that the movie rerun generator can access the rerun, retrieve the rerun descriptor file, retrieve the video clip, and apply logic to determine which among the plurality of video clips to use for substitution in the rerun. The logic of the movie rerun generator can determine if a video clip among the plurality of video clips was used during a previous presentation of a modified video program having the video clip inserted or spliced into the rerun. The logic of the movie rerun generator selects a next video clip if the video clip among the plurality of video clips was used during the previous presentation of the modified video program.

In yet another embodiment, the rerun at 616 is transmitted on a primary channel of the Internet Protocol Television system while the video clip matching the identifier is transmitted on a secondary channel of the Internet Protocol Television system and the primary channel switches to the secondary channel and returns to the primary channel at times defined by the rerun descriptor file. At 618, the movie rerun generator can access and retrieve a video clip from a remote server and splices the video clip into the rerun at a time defined by the rerun descriptor file.

Upon reviewing the aforementioned embodiments, it would be evident to an artisan with ordinary skill in the art that said embodiments can be modified, reduced, or enhanced without departing from the scope and spirit of the claims described below. For example, such a system and method can entail in particular embodiment a network device such as server which can support the metamorphic content generation. Yet other embodiments can carry out some or all of the morphing in other network devices or in mobile devices such as set top boxes or cellular phones for example. In one embodiment, the morphing can be performed based upon factors associated with the potential audience, such as demographics. For instance morphing to include visual attributes that are associated with the potential audience or liked by the potential audience. In another embodiment, the morphing can be performed independently of factors associated with the audience (such as randomly changing hair colors). In the one or more of exemplary embodiments, the morphine can be performed automatically without the need for user intervention.

Other suitable modifications can be applied to the present disclosure without departing from the scope of the claims below. Accordingly, the reader is directed to the claims section for a fuller understanding of the breadth and scope of the present disclosure.

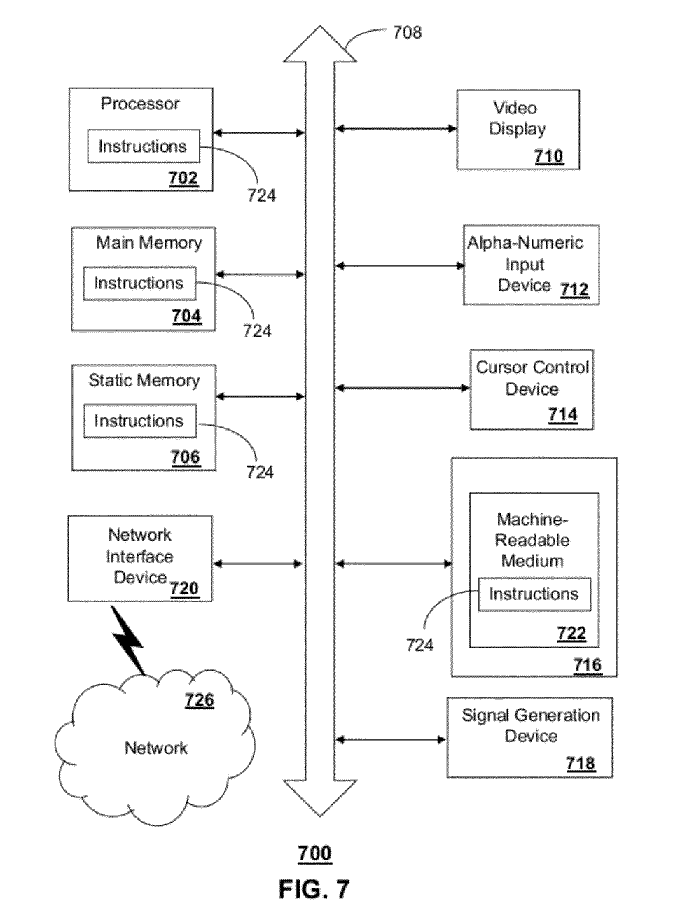

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A network device comprising a controller programmed to:
receive a rerun of a video program in an editable digital format streamed in an Internet Protocol Television system, wherein the rerun has an identifier;
initiate a search of a rerun database for video clips matching the identifier;
retrieve a rerun descriptor file associated with the identifier;
determine an insertion point on the rerun for inserting a video clip matching the identifier using the rerun descriptor file; and
substitute at the insertion point, a portion of the rerun with the video clip matching the identifier.

2. The network device of claim 1, wherein the rerun descriptor file comprises a unique identifier for the rerun, a length of the rerun, a format of the rerun, and an insertion point location identifier for at least one rerun video clip.

3. The network device of claim 2, wherein the rerun descriptor file comprises a last rerun date and time.

4. The network device of claim 1, wherein the controller is programmed to create a modified video program having the video clip inserted or spliced into the rerun and wherein the modified video program is stored in a database of reruns in an off-line mode.

5. The network device of claim 1, wherein the controller is programmed to create a modified video program having the video clip inserted or spliced into the rerun during the broadcast of the rerun in a real-time mode.

6. The network device of claim 1, wherein a plurality of video clips matches the identifier.

7. The network device of claim 6, wherein the controller uses a movie rerun generator to access the rerun, retrieve the rerun descriptor file, retrieve the video clip, and apply logic to determine which among the plurality of video clips to use for substitution in the rerun.

8. The network device of claim 7, wherein the logic of the movie rerun generator determines if a video clip among the plurality of video clips was used during a previous presentation of a modified video program having the video clip inserted or spliced into the rerun.

9. The network device of claim 8, wherein the logic of the movie rerun generator selects a next video clip if the video clip among the plurality of video clips was used during the previous presentation of the modified video program.

10. The network device of claim 1, wherein the rerun is transmitted on a primary channel of the Internet Protocol Television system while the video clip matching the identifier is transmitted on a secondary channel of the Internet Protocol Television system and the primary channel switches to the secondary channel and returns to the primary channel at times defined by the rerun descriptor file.

11. The network device of claim 7, wherein the movie rerun generator accesses and retrieves a video clip from a remote server and splices the video clip into the rerun at a time defined by the rerun descriptor file.

12. The network device of claim 7, wherein the controller forms a portion of a set top box comprising the movie rerun generator.

13. A non-transitory computer readable storage medium comprising computer instructions to:
receive a rerun of a video program in an editable digital format, wherein the rerun has an identifier;
initiate a search of a rerun database for program clips matching the identifier;
retrieve a descriptor file associated with the identifier; and
substitute at an insertion point defined by the descriptor file, a portion of the rerun with the program clip matching the identifier.

14. The storage medium of claim 13, comprising computer instructions to determine the insertion point on the rerun for inserting the program clip matching the identifier using the descriptor file.

15. The storage medium of claim 13, comprising computer instructions to present a modified video program comprising the rerun with the program clip matching the identifier inserted in accordance with the descriptor file.

16. The storage medium of claim 13, wherein the computer instructions comprise instructions to create a modified video program having the program clip inserted or spliced into the rerun.

17. The storage medium of claim 13, wherein the computer instructions comprise instructions in an off-line mode to create a modified video program having the program clip inserted or spliced into the rerun and wherein the modified video program is stored in a database of reruns and instructions in a real-time mode to create the modified video program having the program clip inserted or spliced into the rerun during the broadcast of the rerun.

18. A method comprising:
transmitting a rerun of a video program in an editable digital format to at least one client device in a network, wherein the video program was previously presented at the at least one client device and the rerun has an identifier;
initiating a search of a rerun database for video clips matching the identifier;
retrieving a rerun descriptor file associated with the identifier;
determining an insertion point on the rerun for inserting a video clip matching the identifier using the rerun descriptor file; and
replacing a portion of the rerun at the insertion point with the video clip matching the identifier to create a modified rerun.

19. The method of claim 18, comprising storing the modified rerun in a server having a database of reruns and modified reruns.

20. The method of claim 18, wherein the rerun is transmitted on a primary channel while the video clip matching the identifier is transmitted on a secondary channel o and the primary channel switches to the secondary channel and returns to the primary channel at times defined by the rerun descriptor file and in accordance with signals transmitted from a server to the at least one client device.
